(19) United States
(12) Patent Application Publication
(10) Pub. No.: US 2010/0276581 A1
(43) Pub. Date: Nov. 4, 2010

(54) BOREHOLE NEUTRON GENERATOR WITH UNIQUE ELECTRODE STRUCTURE AND D-D, T-T OR D-T REACTANTS

(75) Inventor: Steven M. Bliven, Magnolia, TX (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/768,878

(22) Filed: Apr. 28, 2010

Related U.S. Application Data
(60) Provisional application No. 61/173,752, filed on Apr. 29, 2009.

(51) Int. Cl. G01V 5/10; G21B 1/11

(52) U.S. Cl. 250/269.4; 250/269.6; 376/100; 376/273

(57) ABSTRACT

An apparatus for performing an operation in a borehole penetrating the earth, the apparatus having: a carrier configured for conveyance through the borehole; and a neutron source disposed at the carrier and configured to produce a nuclear fusion reaction that emits a neutron to perform the operation.

### BACKGROUND OF THE INVENTION

1. Field of the Invention

The invention disclosed herein relates to an apparatus and method for irradiating a downhole environment with neutrons and, in particular, to an electrically energized neutron source.

2. Description of the Related Art

Various operations may be performed in a borehole penetrating the earth in the quest for hydrocarbons. The operations can be related to the exploration and production of hydrocarbons. One type of operation is known as well logging.

Well logging is a technique used to perform measurements of an earth formation, which may contain a reservoir of the hydrocarbons, from within the borehole. In well logging, a logging tool, configured to perform a measurement of the earth formation, is conveyed through a borehole penetrating the earth formation. In one embodiment, an armored cable is used to support and convey the logging tool through the borehole. In general, the wireline contains cables for supplying power to the logging tool and communicating data to and from the logging tool.

The logging tool can be configured to perform various types of measurements of the earth formation. Some of the measurements, such as elemental yields and porosity, require irradiating a portion of the earth formation with neutrons. The measurements of the results of interactions between the neutrons and the earth formation can be related to a property of the earth formation, such as the composition or the porosity of the earth formation.

In one embodiment of the logging tool, a chemical source is used to emit the neutrons needed to perform the measurements. Unfortunately, the chemical source can be costly and not readily available. In addition, because the chemical source is radioactive, certain safety concerns are associated with transporting and using the chemical source.

Therefore, what are needed are techniques for emitting neutrons in a logging tool without using a chemical source. Preferably, the techniques emit neutrons using an electrical source of power.

### BRIEF SUMMARY OF THE INVENTION

Disclosed is an apparatus for performing an operation in a borehole penetrating the earth, the apparatus having: a carrier configured for conveyance through the borehole; and a neutron source disposed at the carrier and configured to produce a nuclear fusion reaction that emits a neutron to perform the operation.

Also disclosed is an apparatus for estimating a property of an earth formation penetrated by a borehole, the apparatus having: a logging tool configured for conveyance through the borehole; a neutron source disposed at the logging tool and configured to produce a nuclear fusion reaction that emits a neutron used for estimating the property; and an instrument configured to measure a result of an interaction between the neutron and the earth formation to estimate the property.

Further disclosed is a method for performing an operation in a borehole penetrating the earth, the method including: conveying a carrier through the borehole; and generating a neutron from a neutron source disposed at the carrier to perform the operation, the neutron being generated by a nuclear fusion reaction.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a logging tool disposed in a borehole penetrating an earth formation;

FIGS. 2A and 2B, collectively referred to as FIG. 2, illustrate an exemplary embodiment of a neutron source disposed at the logging tool;

FIG. 3 depicts aspects of an electron injection device of the form of either a thermionic cathode or a field emitter and associated electrode disposed in a reaction chamber;

FIGS. 4A and 4B, collectively referred to as FIG. 4, depict aspects of an ion source disposed at the reaction chamber;

FIG. 5 depicts aspects of an automatic control system for optimizing or otherwise controlling neutron production; and

FIG. 6 presents one example of a method for performing an operation in the borehole.

### DETAILED DESCRIPTION OF THE INVENTION

Disclosed are exemplary embodiments of techniques for emitting neutrons from a downhole tool. The techniques, which include an apparatus and a method, call for generating free neutrons from nuclear fusion reactions. In one embodiment of the techniques, the nuclear fusion reactions are contained by electrostatic inertial confinement.

For convenience, certain definitions are presented. The term “fusible” relates to atomic nuclei that can join together or fuse in a nuclear fusion reaction. The term “electrostatic inertial confinement” relates to using an electric field to accelerate and confine ions of fusible nuclei in a gaseous state in order to increase the probability of the ions undergoing a nuclear fusion reaction.

In a nuclear fusion reaction, atomic nuclei join together to form a nucleus that is heavier than each of the individual nuclei joined together. The techniques disclosed herein include those nuclear fusion reactions that emit a neutron when the atomic nuclei join together. For example, in a deuterium-tritium nuclear fusion reaction, the nucleus of a deuterium atom and the nucleus of a tritium atom join together or fuse to form a helium nucleus and emit a neutron in the process. Other non-limiting examples of nuclear fusion reactions that emit a neutron include deuterium-deuterium and tritium-tritium.

A reaction chamber is used to initiate and contain the nuclear fusion reaction. The reaction chamber contains a gas of the nuclei that undergo the nuclear fusion reaction. In one embodiment, the reaction chamber is configured as an inertial electrostatic confinement (IEC) device. The IEC device includes at least one anode and one cathode. In the IEC device, an applied electric field between an anode and a cathode is used to accelerate atomic nuclei in the form of ions towards the center of the chamber. The ions gain energy as they accelerate and form a high ion density cloud. Ions of the gas in the high ion density cloud in turn can collide with each other or with neutral gas constituents in the reaction volume to cause nuclear fusion reactions. From the nuclear fusion reactions, neutrons are emitted.

The emitted neutrons are used to perform an operation downhole such as well logging. While embodiments of well logging are discussed for teaching purposes, the emitted neutrons can be used in any operation requiring an interaction between the neutrons and some material. For well logging, the neutrons interact with an earth formation or a material in a borehole.

Ions of the fusible gas can be generated in several ways. In one embodiment, the reaction chamber includes at least one additional electrostatically charged grid that can confine free electrons emitted by a thermionic cathode. The electrons in turn can collide with the atoms of the gas and ionize these atoms. In another embodiment, a Penning cell discharge coupled to the reaction chamber is used as a source of the ions. In yet another embodiment, direct current (DC) glow discharge is used to produce the ions in the fusible gas at a low pressure.

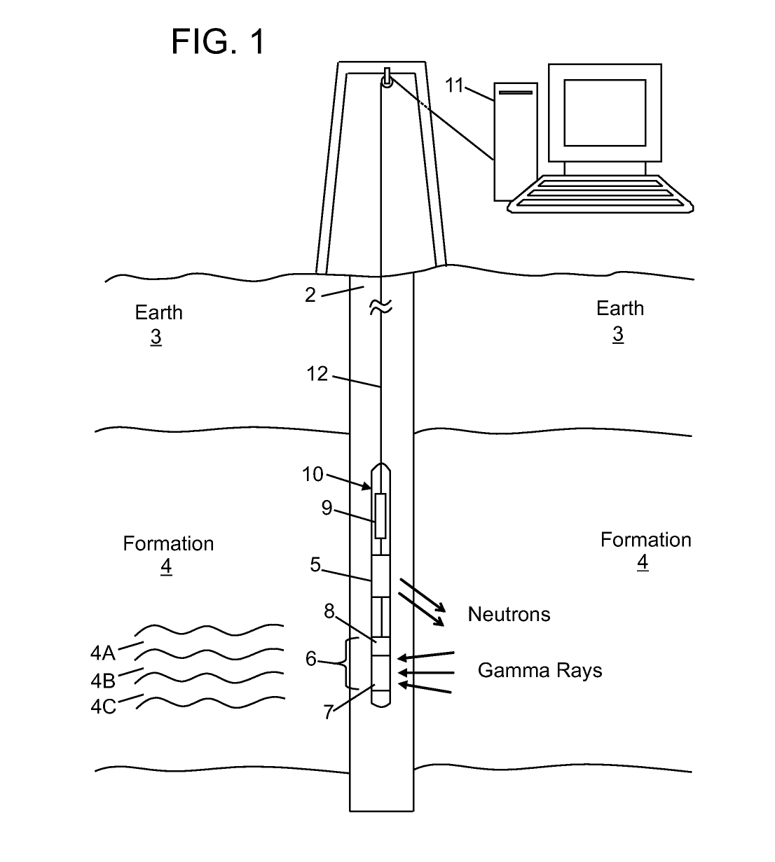

Reference may now be had to FIG. 1. FIG. 1 illustrates an exemplary embodiment of a logging tool 10 disposed in a borehole 2 penetrating the earth 3. The earth 3 includes an earth formation 4, which can include various layers 4A-4C. The logging tool 10 includes a neutron source 5. The neutron source 5 is configured to emit neutrons produced from a nuclear fusion reaction as discussed above. The neutrons travel into the formation 4 and interact with the elements in the formation 4. The logging tool 10 also includes an instrument 6 configured to detect and measure results of the interactions.

In one example of an interaction, a gamma ray is emitted from an interaction between a neutron and an element of the formation 4. Accordingly, the instrument 6 can be configured to detect the gamma ray and measure an amount of energy associated with the gamma ray. In an embodiment as a gamma ray detector, the instrument 6 in general includes a scintillator 7 and a photodetector 8. The scintillator 7 interacts with the gamma ray to produce an amount of light. The photodetector 8 measures the amount of light to determine the amount of energy associated with the gamma ray. Non-limiting properties of the formation 4 that may be determined with the logging tool 10 include porosity, elemental yields, and a boundary between layers 4A-4C.

Referring to FIG. 1, the logging tool 10 includes an electronic unit 9. The electronic unit 9 can be used to operate the logging tool 10 and/or store data from measurements performed by the logging tool 10. For example, the electronic unit 9 can monitor components in the neutron source 5 and set parameters such as voltage levels to enable operation of the neutron source 5. When the electronic unit 9 stores data, the data can be retrieved when the logging tool 10 is removed from the borehole 2. Alternatively, the data can be transmitted to a processing system 11 disposed at the surface of the earth 3 using a telemetry system such as wired pipe or pulsed-mud for example. The processing unit 11 can also be configured to send commands to the logging tool 10.

Referring to FIG. 1, a wireline 12 is used to support the logging tool 10 and to convey the logging tool 10 through the borehole 2. As an alternative, a slickline, coiled tubing or a drill string may be used to convey the logging tool 10 through the borehole 2.

For purposes of this discussion, it is shown in FIG. 1 that the borehole 2 is vertical and the layers 4A-4C are horizontal. The teachings herein, however, can be applied equally well in deviated or horizontal wells or with the formation layers 4A-4C at any arbitrary angle. The teachings are equally suited for use in logging-while-drilling (LWD) applications and in open-borehole and cased-borehole applications. In LWD applications, the logging tool 10 may be disposed in a collar attached to the drill string. When used in LWD applications, drilling may be halted temporarily to prevent vibrations while the logging tool 10 is performing a measurement.

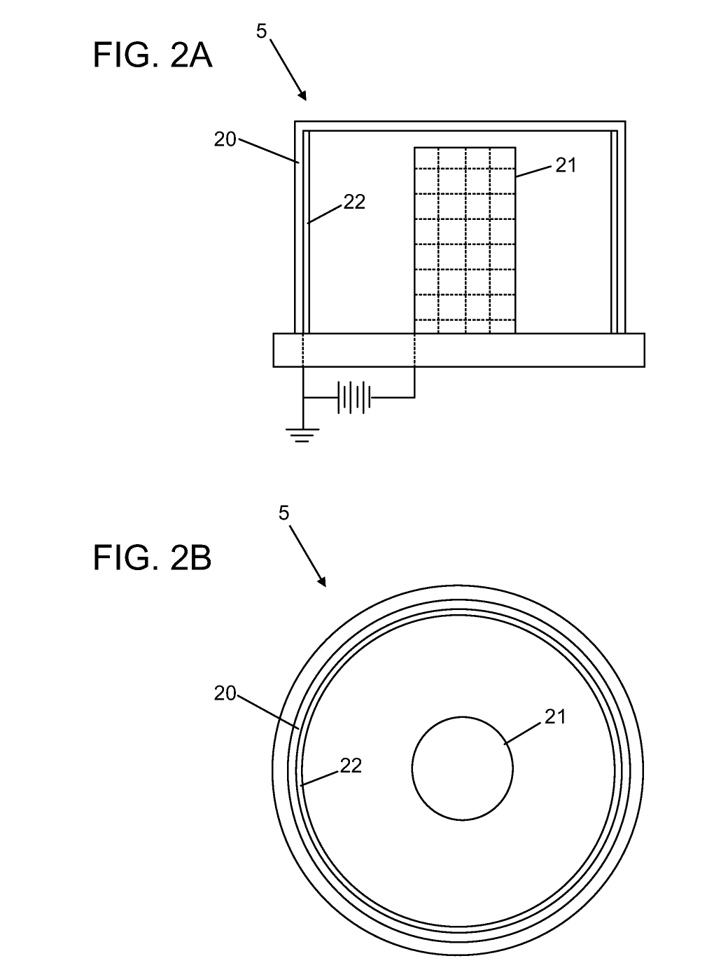

The neutron source 5 is now discussed in more detail. FIG. 2 illustrates an exemplary embodiment of the neutron source 5. FIG. 2A illustrates a cross-sectional side view of the neutron source 5. The neutron source 5 includes a reaction chamber 20 configured to contain a nuclear fusion reaction. The reaction chamber 20 contains components necessary to produce the nuclear fusion reaction. The reaction chamber 20 is configured to contain a gas of fusible nuclei at low pressures on the order of 4.0 Pa or less. Disposed inside the reaction chamber 20 and positioned relative to the reaction chamber 20 is a transparent cathode grid 21. In the embodiment of FIG. 2, the reaction chamber 20 is configured to be an anode 22 with respect to the cathode grid 21. Thus, the anode 22 can be the reaction chamber 20. The cathode grid 21 is configured to be transparent to ions formed from the gas of fusible nuclei thereby minimizing a loss of ions to the grid and allowing recirculation of ions that do not undergo a nuclear fusion reaction. The recirculated ions increase the chance for these ions to undergo the nuclear fusion reaction in the future. FIG. 2B illustrates a top cross-sectional view of the neutron source 5.

As shown in FIG. 2, the reaction chamber 20 (and therefore the anode 22) and the cathode grid 21 are cylindrically shaped. In other embodiments, the anode 22 and the cathode grid 21 can be spherically shaped or have other shape. The cathode grid 21 may be concentric or otherwise contoured relative to the anode 22 in order to focus the ions to the center of chamber 20. By focusing the ions to the center of the chamber 20, a sufficient density of the ions are formed that increase the probability of the ions colliding and producing a nuclear fusion reaction. With the anode grounded, the voltage applied to the cathode grid is generally in the range of −50 to −200 kV.

In general, factors such as the shape and configuration of the reaction chamber 20, the anode 22, and the cathode 21 are selected to achieve a type or pattern of neutron discharge. For example, the factors can be selected to achieve a discharge of neutrons from approximately a point source. Alternatively, the factors can be selected to achieve a discharge of neutrons from a line source of a certain shape or from an area of a certain shape.

In the glow discharge mode, the gas of fusible nuclei is partially ionized by the electric field established between the anode 22 and the cathode 21 with the gas pressure at about 1 to 3 Pa for deuterium.

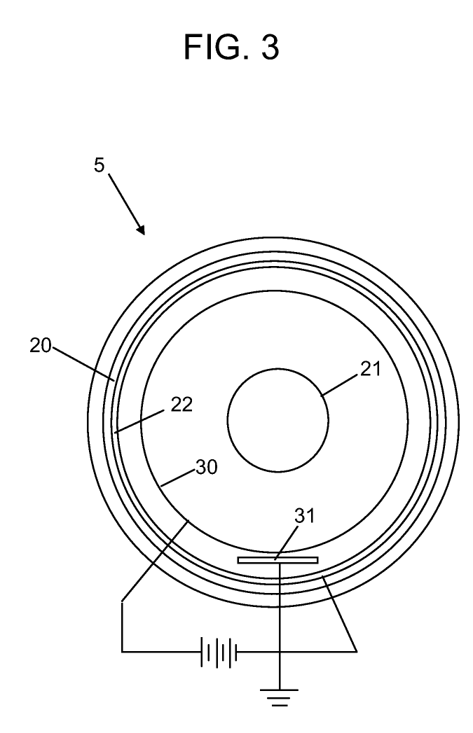

A suppression scheme may be used to suppress electrons emitted by secondary emission in order to minimize current and associated power that is unproductive toward neutron generation. The suppression scheme can include one or more electrodes 30 disposed in the reaction chamber 20 generally between the anode 22 and the cathode 21 as shown in a top cross-sectional view in FIG. 3. The structure of each electrode 30 is transparent and can be a grid assembly similar to the cathode 21. In general, the structure of the electrode 30 has the same shape as the cathode 21. The electrode 30 is energized at an appropriate voltage to minimize the flow of electrons from the cathode 21.

The number of ions available for nuclear fusion may be increased over the amount created by the glow discharge mode in several ways. In one way, referring to FIG. 3, a thermionic cathode 31 is disposed adjacent to the electrode 30 inside the reaction chamber 20. The thermionic cathode 31 or alternatively, a field emitter 31 is electrically energized with a negative potential with respect to the electrode 30 to emit electrons. By minimizing electron flow to the cathode 21, the electrode 30 confines the emitted electrons to an annular cloud about the electrodes 30. The cloud of electrons ionizes the neutral gas of fusible nuclei to form ions of fusible nuclei.

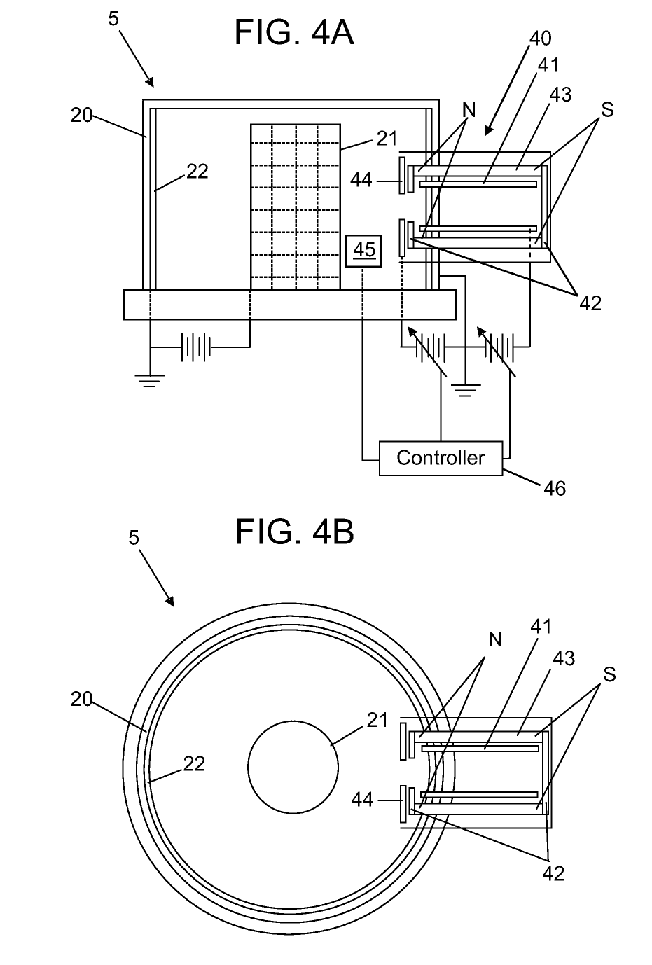

The number of ions available for nuclear fusion may also be increased by using an ion source coupled to the reaction chamber 20. FIG. 4A illustrates a side cross-section view of a Penning cell 40 (ion source 40) disposed at the reaction chamber 20. FIG. 4B illustrates a top cross-sectional view of the Penning cell 40. The Penning cell 40 includes a cylindrical anode 41, which may be the housing of the ion source 40, and shaped Penning cell cathode elements 42. The housing, in FIG. 4, forms part of a pressure boundary with the reaction chamber 20. Alternatively, the reaction chamber 20 can include a volume configured to contain the ion source 40. An ion source axis symmetric magnetic field structure internal to the anode 42 of the Penning cell is established through the use of either a solenoidally configured and controlled structure or alternatively through the use of permanent magnets 43, either of which may be external to the sealed reaction chamber volume. The resulting electric and magnetic fields work to confine generated free electrons in the volume bounded by the cylindrical anode 41 and the cathode 42. The confined electrons ionize the gas of fusible nuclei to form the ions of the fusible nuclei. Ions are injected into the reaction volume by extracting them from the volume of the Penning cell 40 through the use of voltage applied to extraction electrode 44.

An automatic system may be used to control the extent of the discharge of the ion source, the relative energy of the injected ions, and the preferred position of the region of neutron production. That is, the extent of discharge in the ion source 40 and the extraction may be controlled to adjust the number and energy of ions injected into the reaction chamber 20, to a location that optimizes the generation of neutrons. Depicted in FIG. 4 are a detector 45, a controller 46, and electrically adjustable devices 41 and 44 that are included in an exemplary embodiment of the automatic system. The neutron detector 45 measures the relative number of neutrons being generated and provides this measurement to the controller 46. The controller 46 in turn adjusts the degree of discharge of the ion source 40 within the reaction chamber 20 to a point where neutron generation can be manipulated.

Other processes used for generating neutrons by nuclear fusion reactions can be also optimized by using the automatic control system. Referring to a side cross-sectional view in FIG. 5, the controller 46 receives input from the detector 45. The controller 46 can optimize the number of neutrons produced by providing control signals to a gas reservoir 47. The gas reservoir 47 may be either of the integral type or of the indirectly heated type and may be of any suitable material for absorbing and releasing hydrogen isotopic gases reversibly. In addition, the controller 46 can provide control signals to a power supply 53 for adjusting voltages of the various anodes and cathodes used in the neutron source 5 to control and optimize neutron production.

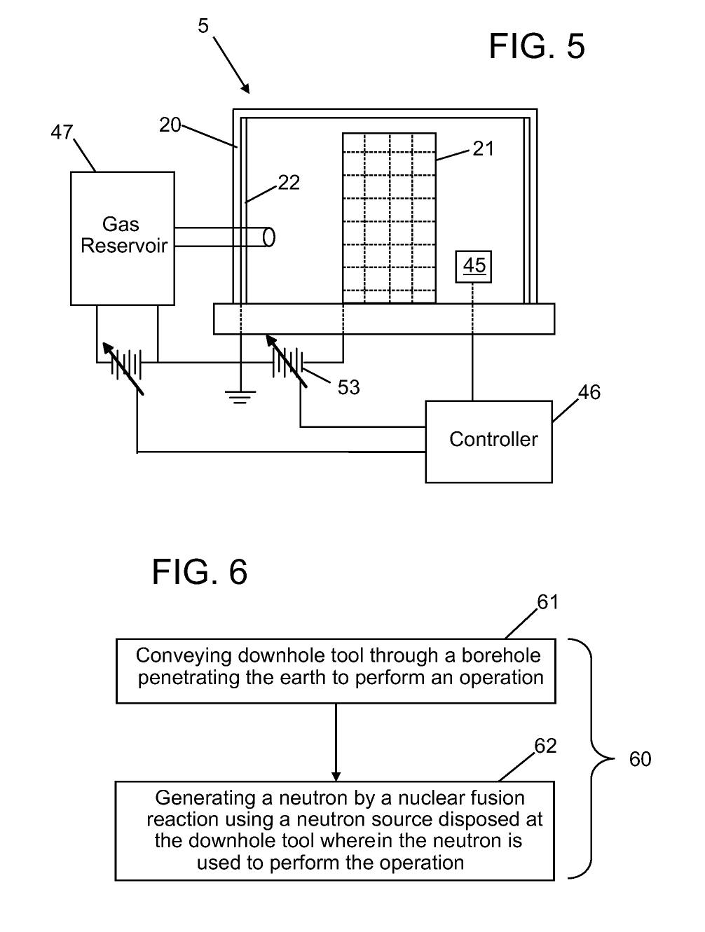

FIG. 6 presents one example of a method 60 for performing an operation in the borehole 2 penetrating the earth 3. The method 60 calls for (step 61) conveying the downhole tool 10 through the borehole 2. Further, the method 60 calls for (step 62) generating a neutron by a nuclear fusion reaction using the neutron source 5 disposed at the downhole tool 10 wherein the neutron is used to perform the operation. While the method 60 discusses generating “a neutron,” this term is intended to include a plurality of neutrons or neutron flux.

The term “carrier” as used herein means any device, device component, combination of devices, media and/or member that may be used to convey, house, support or otherwise facilitate the use of another device, device component, combination of devices, media and/or member. Exemplary non-limiting carriers include drill strings of the coiled tube type, of the jointed pipe type and any combination or portion thereof. Other carrier examples include casing pipes, wirelines, wireline sondes, slickline sondes, drop shots, downhole subs, bottom hole assemblies (BHAs) downhole tools, logging tools, drill string inserts, modules, internal housings and substrate portions thereof.

In support of the teachings herein, various analysis components may be used, including a digital and/or an analog system. For example, the electronic unit 9 or the processing system 11 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a sample line, sample storage, sample chamber, sample exhaust, pump, piston, power supply (e.g., at least one of a generator, a remote supply and a battery), voltage supply, vacuum supply, pressure supply, cooling component, heating component, motive force (such as a translational force, propulsional force or a rotational force), magnet, electromagnet, sensor, electrode, transmitter, receiver, transceiver, antenna, controller, optical unit, chemical analysis unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for performing an operation in a borehole penetrating the earth, the apparatus comprising:
a carrier configured for conveyance through the borehole; and
a neutron source disposed at the carrier and configured to produce a nuclear fusion reaction that emits a neutron to perform the operation.

2. The apparatus of claim 1, wherein the neutron source comprises a reaction chamber configured to contain the nuclear fusion reaction.

3. The apparatus of claim 2, where in a shape of the reaction chamber is at least one of cylindrical and spherical.

4. The apparatus of claim 2, wherein a gas of fusible nuclei is disposed in the reaction chamber.

5. The apparatus of claim 4, wherein the nuclei comprise at least one selection from a group consisting of deuterium and tritium.

6. The apparatus of claim 2, wherein an anode and a cathode are disposed within the reaction chamber and configured to accelerate ions of fusible nuclei to produce the nuclear fusion reaction.

7. The apparatus of claim 6, wherein the cathode comprises a grid configured to be transparent to the ions.

8. The apparatus of claim 6, wherein the cathode is concentric to the anode.

9. The apparatus of claim 8, wherein the anode and cathode are concentric to the reaction chamber.

10. The apparatus of claim 6, wherein the reaction chamber is the anode.

11. The apparatus of claim 6, wherein an electrode is disposed between the anode and cathode, the electrode being configured to be transparent to the ions and to limit secondary emissions of electrons from flowing from the cathode.

12. The apparatus of claim 11, further comprising at least one of a thermionic cathode assembly and a field emitter cathode assembly, each electrically coupled to the electrode via a power supply and configured to generate electrons for ionizing the fusible nuclei.

13. The apparatus of claim 6, further comprising a separate ion source construction coupled to the reaction chamber and configured to inject ions of the fusible nuclei into the reaction chamber.

14. The apparatus of claim 13, further comprising an electrically driven device operatively coupled to the ion source and configured to manipulate the extent of a discharge from the ion source and the energy of injected ions extracted to a reference point in the reaction chamber.

15. The apparatus of claim 1, wherein the neutron source is configured to be at least one of a point source and a distributed source.

16. The apparatus of claim 1, wherein the carrier is selected from a group consisting of a downhole tool, a logging tool, a wireline, a slickline, coiled tubing, and a drill string.

17. An apparatus for estimating a property of an earth formation penetrated by a borehole, the apparatus comprising:
a logging tool configured for conveyance through the borehole;
a neutron source disposed at the logging tool and configured to produce a nuclear fusion reaction that emits a neutron used for estimating the property; and
an instrument configured to measure a result of an interaction between the neutron and the earth formation to estimate the property.

18. The apparatus of claim 17, wherein the instrument comprises a nuclear detector configured to measure at least one of a gamma ray and a neutron from the interaction between the neutron and the earth formation.

19. The apparatus of claim 17, wherein the property is selected from a group consisting of density, porosity, elemental yield, and a boundary between layers of the earth formation.

20. A method for performing an operation in a borehole penetrating the earth, the method comprising:
conveying a carrier through the borehole; and
generating a neutron from a neutron source disposed at the carrier to perform the operation, the neutron being generated by a nuclear fusion reaction.
